(19) United States
(12) Patent Application Publication
(10) Pub. No.: US 2009/0037576 A1
(43) Pub. Date: Feb. 5, 2009

(54) DATA ANALYZING SYSTEM AND DATA ANALYZING METHOD

(75) Inventors: Kazuto Kubota, Kawasaki-Shi (JP); Hisaaki Hatano, Yokohama-Shi (JP)

Correspondence Address: AMIN, TUROCY & CALVIN, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/175,563

(22) Filed: Jul. 18, 2008

(30) Foreign Application Priority Data
Jul. 25, 2007 (JP) 2007-193600

(51) Int. Cl. G06F 15/173

(52) U.S. Cl. 709/224

(57) ABSTRACT

A data analyzing system includes an input-output device, a plurality of local analyzing devices, a center analyzing device and a connecting device which connects between the input-output device, the local analyzing devices, and the center analyzing device. The connecting device may receive and execute a forwarding setting command from the input-output device to select and set one or more devices, to which the command from the input-output device should be forwarded, from the local analyzing devices and the center analyzing device and forward a command different from the forwarding setting command transmitted from the input-output device to the devices, in which forwarding is set, and forward data or command transmitted from the local analyzing devices and the center analyzing device, in accordance with destinations described in the data or the command.

### CROSS REFERENCE TO RELATED APPLICATIONS

This application is based upon and claims the benefit of priority from the prior Japanese Patent Applications No. 2007-193600, filed on Jul. 25, 2007; the entire contents of which are incorporated herein by reference.

### BACKGROUND OF THE INVENTION

1. Field of the Invention

The present invention relates to a data analyzing system and a data analyzing method for analyzing observed values obtained by observing a plurality of local devices.

2. Related Art

Demand for remote monitoring is rising in order to improve the safety of devices and reduce the monitoring cost. One of the things that should be attained in the remote monitoring is monitoring of abnormality. An abnormality of a device is determined from values of a sensor. An upper limit and a lower limit are provided to the sensor, and with a deviation from the range, the device is regarded as abnormal. The upper limit and the lower limit may be provided as constant values or may be calculated and momentarily changed based on values of other sensors. The rule for determining the abnormality based on the upper limit and the lower limit is called a monitoring logic. The monitoring logic can be generated by using history data of sensor values of a monitored device. The sensor history data is collected to an analyzing server (center analyzing device), and an analyzer uses analysis software to create the monitoring logic.

Meanwhile, a price reduction of a CPU (Central Processing Unit), a memory, and a hard disk that constitute a personal computer (PC: Personal Computer) has enabled to install a data analyzing device to the monitored device. A method for analyzing a large amount of data using a plurality of data analyzing devices is described, for example, JP-A 2001-167098 (Kokai). This method attempts to achieve faster processing by processing identical data by a multiplicity of data analyzing devices.

The number of devices to be remotely monitored may be tens of thousands or hundreds of thousands. Therefore, collecting and analyzing all sensor history data to the analyzing server is difficult due to the load to the analyzing server and the communication load. Thus, the monitoring logic is created from part of the sensor history data of the monitored devices. However, there are individual differences in the monitored devices even within the same model. Therefore, the monitoring logic created from part of the sensor history data may not apply to other identical devices.

### SUMMARY OF THE INVENTION

According to an aspect of the present invention, there is provided with a data analyzing system comprising:

an input-output device operated by a user;

a plurality of local analyzing devices each of which performs a first data analysis of analyzing observed values obtained from each of local devices corresponding each of the local analyzing devices to obtain first analyzed data, respectively;

a center analyzing device which performs a second data analysis of analyzing the first analyzed data to obtain second analyzed data; and

a connecting device which connects between the input-output device, the local analyzing devices, and the center analyzing device,

(A) the input-output device comprising:

an inputting unit configured to input a command by the user;

a first communicating unit configured to transmit an inputted command to the connecting device and to receive data from the center analysis device and the local analysis devices via the connecting device; and

a data outputting unit configured to output received data

(B) each of the local analyzing devices comprising:

a second communicating unit configured to transmit and receive a command or data to and from the input-output device, the center analysis device and other local analyzing devices via the connecting device;

a data acquiring unit configured to acquire observed values from the local devices corresponding to the local analyzing devices;

a first analysis command executor configured to receive and execute a first data analysis command from the input-output device through the second communicating unit to perform the first data analysis using the observed values and configured to transmit the first analyzed data to the input-output device through the second communicating unit; and

a first communication command executor configured to receive and execute a first communication command through the second communicating unit from the input-output device to provide the first analyzed data to at least one of the center analyzing device and other local analyzing devices and configured to receive and execute a second communication command through the second communicating unit from the input-output device to acquire the first or second analyzed data from at least one of the center analyzing device and the other local analyzing devices,

(C) the center analyzing device comprising

a third communicating unit configured to transmit and receive a command or data to and from the input-output device and the local analysis devices via the connecting device; and

a second analysis command executor configured to receive and execute a second data analysis command through the third communicating unit from the input-output device to perform the second data analysis using the first analyzed data acquired in advance and configured to transmit the second analyzed data to the input-output device through the third communicating unit, and

(D) the connecting device comprising:

a command executing unit configured to receive and execute a forwarding setting command from the input-output device to select and set one or more devices, to which the command from the input-output device should be forwarded, from the local analyzing devices and the center analyzing device;

a first forwarding unit configured to forward a command different from the forwarding setting command transmitted from the input-output device to the devices, in which forwarding is set; and

a second forwarding unit configured to forward data or command transmitted from the local analyzing devices and the center analyzing device, in accordance with destinations described in the data or the command.

According to an aspect of the present invention, there is provided with a data analyzing system comprising:

an input-output device operated by a user;

a plurality of local analyzing devices each of which performs a first data analysis by using observed values obtained by observing local devices corresponding the local analyzing devices to obtain first analyzed data, respectively;

a center analyzing device configured to perform a second data analysis using the first analyzed data to obtain second analyzed data; and

a connecting device configured to connect between the input-output device, the local analyzing devices, and the center analyzing device,

(A) the input-output device comprising:

an inputting unit configured to input a command by the user;

a first communicating unit configured to transmit an inputted command to the connecting device and to receive data from the center analysis device and the local analysis devices via the connecting device; and

a data outputting unit configured to output received data,

(B) each of the local analyzing devices comprising:

a second communicating unit configured to transmit and receive a command or data to and from the input-output device, the center analysis device and other local analyzing devices via the connecting device;

a data acquiring unit configured to acquire observed values by observing the local devices corresponding to the local analyzing devices; and

a first analysis command executor configured to receive and execute a first data analysis command through the second communicating unit from the input-output device to perform the first data analysis using the observed values and configured to transmit the first analyzed data to the input-output device through the second communicating unit;

(C) the center analyzing device comprising:

a third communicating unit configured to transmit and receive a command or data to and from the input-output device and the local analysis devices via the connecting device; and

a second analysis command executor configured to receive and execute a second data analysis command through the third communicating unit from the input-output device to perform the second data analysis using the first analyzed data acquired in advance and configured to transmit the second analyzed data to the input-output device through the third communicating unit, and

(D) the connecting device comprising:

a command executing unit configured to receive and execute a forwarding setting command from the input-output device to select and set one or more devices, to which the command from the input-output device should be forwarded, from the local analyzing devices and the center analyzing device;

a first forwarding unit configured to forward a command different from the forwarding setting command transmitted from the input-output device to devices, in which forwarding is set;

a second forwarding unit configured to forward data or a command transmitted from the local analyzing devices and the center analyzing device, in accordance with destinations of the data or the command; and

a third communication command executor
configured to receive and execute a fifth communication command from the input-output device to acquire the first or second analyzed data from the local analyzing devices or the center analyzing device in which the forwarding is set and provide acquired data to at least one of the center analyzing device and the local analyzing devices and
configured to receive and execute a sixth communication command from the input-output device to acquire the first or second analyzed data from at least one of the center analyzing device and the local analyzing devices and provide acquired data to the center analyzing device and the local analyzing devices in which the forwarding is set.

According to an aspect of the present invention, there is provided with a method of performing data analysis by using an input-output device operated by a user; a plurality of local analyzing devices each of which performs a first data analysis to obtain first analyzed data; a center analyzing device which performs a second data analysis of analyzing the first analyzed data to obtain second analyzed data; and a connecting device which connects between the input-output device, the local analyzing devices, and the center analyzing device, comprising:

acquiring observed values from each of local devices corresponding to each of the local analyzing devices;

selecting one or more local analyzing devices to which the command from the input-output device should be forwarded and setting selected local analyzing devices to the connecting device;

transmitting a first data analysis command for performing the first data analysis of analyzing the observed values from the input-output device to the connecting device and forwarding by the connecting device the first data analysis command to said set local analyzing devices to make said set local analyzing devices to execute the first data analysis;

transmitting the first analyzed data obtained by the first data analysis from said set local analyzing devices to the input-output device via the connecting device;

transmitting the first analyzed data obtained by said set local analyzing devices to the center analyzing device via the connecting device;

setting the center analysis device to the connecting device as a device to which the command from the input-output device should be forwarded;

transmitting a second data analysis command for performing the second data analysis of analyzing the first analyzed data from the input-output device to the connecting device and forwarding by the connecting device the second data analysis command to said set center analysis device to make said set center analysis device to execute the second data analysis command; and

transmitting the second analyzed data obtained by the second data analysis from the center analysis device to the input-output device via the connecting device.

### BRIEF DESCRIPTION OF THE DRAWINGS

FIG. 1 depicts a configuration of a distributed data analyzing system according to an embodiment of the present invention;

FIG. 2 depicts a configuration of a connecting device according to a first embodiment;

FIG. 3 depicts a configuration of a data analyzing device according to the first embodiment;

FIG. 4 depicts a configuration of a center analyzing device according to the first embodiment;

FIG. 5 depicts a configuration of an information acquiring table according to the first embodiment;

FIG. 6 depicts a configuration of forwarding destination information storage according to the first embodiment;

FIG. 7 depicts an example of a communication command;

FIG. 8 depicts a data analysis example 1 performed using the system of FIG. 1;

FIG. 9 depicts a data analysis example 2 performed using the system of FIG. 1;

FIG. 10 depicts an expanded example of the information acquiring table; and

FIG. 11 depicts a configuration of a connecting device according to a second embodiment.

### DETAILED DESCRIPTION OF THE INVENTION

### First Embodiment

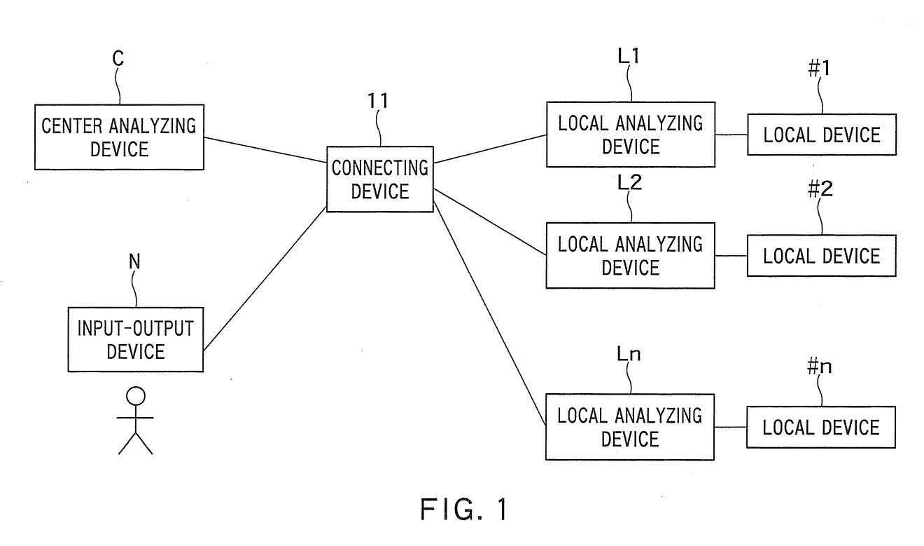

FIG. 1 depicts a configuration of a distributed data analyzing system for easily and quickly generating a monitoring logic reflecting individual differences of monitored devices (local devices) as an embodiment of the present invention.

In the distributed data analyzing system, local analyzing devices L1 to Ln, a center analyzing device C, and an input-output device N are connected through a connecting device 11. Local devices #1 to #n to be monitored are connected to the local analyzing devices L1 to Ln.

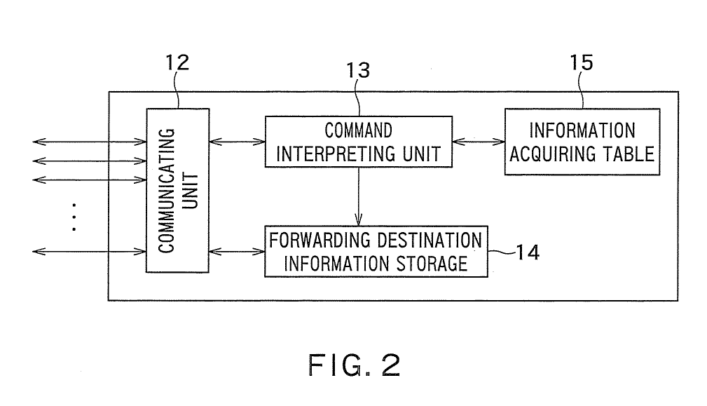

FIG. 2 schematically depicts a configuration of the connecting device 11.

The connecting device 11 includes a communicating unit 12, a command interpreting unit 13, forwarding destination information storage 14, and an information acquiring table 15. The communicating unit 12 is equivalent to a fourth communicating unit, and the command interpreting unit 13 is equivalent to a command executing unit, a first forwarding unit, and a second forwarding unit.

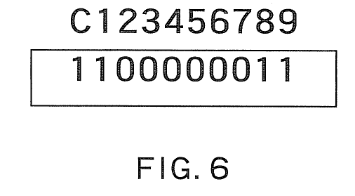

The forwarding destination information storage 14 stores bit strings describing data analyzing devices (the center device and the local analyzing devices are collectively referred to as data analyzing devices) to which a command transmitted from the input-output device N should be forwarded. FIG. 6 depicts an example of content of the forwarding destination information storage 14. Ten fields “C123456789” and bit values corresponding to the fields are illustrated. The bits indicate whether to forward the command from the input-output device N to the center analyzing device C and the local analyzing devices L1 to L9.

The command interpreting unit 13 receives a “connect” command (forwarding setting command) and a “register” command from the input-output device N through the communicating unit 12. The input-output device N includes a first communicating unit that communicates with the connecting device 11, an inputting unit for a user to input a command, and a data outputting unit that outputs (displays, for example) data to the user. The command interpreting unit 13 interprets and executes the commands “connect” and “register” received from the input-output device N. When receiving a command other than the “connect” command and the “register” command from the input-output device N, the command interpreting unit 13 forwards (broadcasts) the received command to forwarding destinations (local analyzing devices L1 to Ln and center device C) in which “1” is set to the field in the forwarding destination information storage 14 through the communicating unit 12.

Information of the sender (for example, input-output device) is appended, as a header, to a command other than the “connect” command and the “register” command, and the receiver of the command can recognize from which device the command has been transmitted. The receiver of the command will return the execution result (for example, analysis result of data) of the command (for example, data analysis command) to the sender. In that case, the receiver directly designates the destination to return the execution result, and the execution result is distributed according to the destination. Thus, the command and the data (these are collectively referred to as “message”) to be transmitted from the data analyzing device to the destinations, such as the input-output device, the connecting device, and other data analyzing devices, are transmitted as follows.

Two types of messages (commands and data) are exchanged between the input-output device and the data analyzing device: (i) an indirect message and (ii) a direct message. The types of the messages are distinguished by a message identifying flag appended at the top of the message. The destinations of the indirect message are determined by the values (bit string) of the forwarding destination information storage 14. On the other hand, in the direct message, destination information is described after the message identifying flag, and the command interpreting unit 13 forwards the message to the destinations described in the destination information regardless of the values of the forwarding destination information storage 14 (obviously, the message is not transmitted further if the connecting device is the destination). The message identifying flag is not appended by the user, but automatically set up by the data analyzing device. As described, the command interpreting unit 13 forwards commands other than “connect” and “register” inputted by the user to destinations in accordance with the values of the forwarding destination information storage 14. Therefore, the command inputted by the user is an indirect message. A message in which the data analyzing device returns the result of data analysis and a message, such as “Put” and “Get” commands described below, in which the data analyzing devices determine destination devices to directly transfer the data are direct messages. Therefore, the data analyzing devices append the destinations to the message and transmit the message to the connecting device 11, and the command interpreting unit 13 executes the forwarding process, thereby delivering the message to desired destination devices.

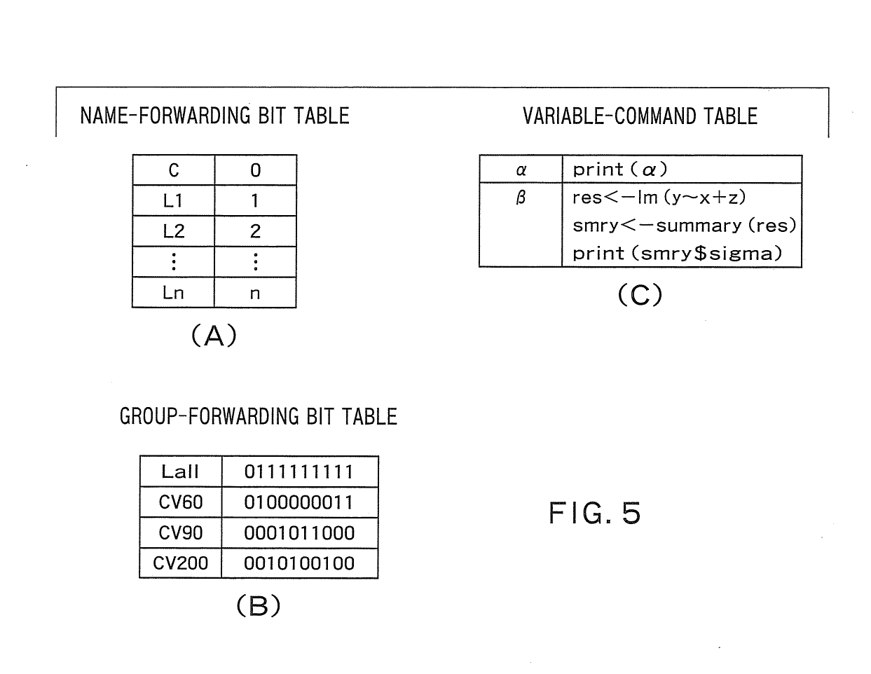

The information acquiring table 15 includes three tables, i.e., “name-forwarding bit table”, “group-forwarding bit table”, and “variable-command table”. An example of these three tables are illustrated in FIGS. 5A to 5C.

The name-forwarding bit table of FIG. 5(A) stores a correspondence between names of the data analyzing devices and bit positions of the data analyzing devices in the bit string stored in the forwarding destination information storage 14. For example, the value corresponding to “L2” in the name-forwarding bit table is “2”. Therefore, the bit position of the data analyzing device L2 in the forwarding destination information storage 14 is the second (the third from the left in FIG. 6, with the far left being 0th).

The group-forwarding bit table of FIG. 5(B) stores a correspondence between group names provided to groups consisted of one or a plurality of data analyzing devices and the data analyzing devices belonging to the groups. More specifically, the group-forwarding bit table stores the correspondence between the group names and the bit string in which the bit positions of the data analyzing devices belonging to the groups are “1” and the bit positions of other data analyzing devices are “0”. For example, a group “Lall” includes a bit string “0111111111” so that the data analyzing devices belonging to the group “Lall” are the data analyzing devices L1 to L9. A group “CV60” includes a bit string “0100000011” so that the data analyzing devices belonging to the group “CV60” are the data analyzing devices L1, L8, and L9.

The variable-command table of FIG. 5(C) stores a correspondence between variables that can be provided to arguments of the command (“connect” or “register”) received from the input-output device N and an analysis command executable by the data analyzing devices. The variable-command table is equivalent to, for example, a command table.

As described, the command interpreting unit 13 interprets and executes the “connect” command and the “register” command received from the input-output device N through the communicating unit 12. An operation of the command interpreting unit 13 based on the “connect” command and the “register” command will be described below.

An operation of the command interpreting unit 13 executing the “connect” command will be described first.

The “connect” command adopts values or conditional expressions as arguments.

If the arguments of the “connect” command are values, the command interpreting unit 13 first searches a name field in the name-forwarding bit table of FIG. 5(A), with the values of the arguments being the key, thereby examining whether the values of the arguments exist. If the retrieval is successful, the command interpreting unit 13 acquires the bit positions included in the retrieved entry from the name-forwarding bit table, sets “1” to the forwarding bits of the forwarding destination information storage 14 in the acquired bit positions, and clears (set “0”) the remaining bit positions. If the values of the arguments do not exist in the name-forwarding bit table, the command interpreting unit 13 searches the group names of the group-forwarding bit table of FIG. 5(B), with the values of the arguments being the key. If the retrieval is successful, the command interpreting unit 13 copies the bit string included in the retrieved entry and overwrites the forwarding destination information storage 14. If the retrieval is unsuccessful in both of the name-forwarding bit table and the group-forwarding bit table, the command interpreting unit 13 returns an error to the user through the input-output device N.

For example, assuming that the user has inputted a command “connect(L2)” in the input-output device N, the inputted command “connect(L2)” is transferred to the command interpreting unit 13 through the communicating unit 12. Since the argument “L2” is a value (not a conditional expression), the command interpreting unit 13 first searches the name-forwarding bit table of FIG. 5(A). The retrieval is successful because an entry “L2” exists in the table, and a bit position “2” included in the retrieved entry is obtained. Based on the acquired bit position “2”, the command interpreting unit 13 sets the third bit from the left of the forwarding destination information storage 14 to “1” and clears the bits of the rest of the positions (sets to “0”). If the user has inputted “connect(CV60)”, the command interpreting unit 13 first searches the name-forwarding bit table of FIG. 5(A) by the argument “CV60” but then searches the group-forwarding bit table of FIG. 5(B) because the retrieval is not successful. The retrieval becomes successful, an entry having “CV60” is discovered in the table, and a bit string “1100000011” included in the discovered entry is obtained. The command interpreting unit 13 then overwrites the forwarding destination information storage 14 based on the acquired bit string “1100000011”.

On the other hand, if the arguments of the “connect” command are conditional expressions, the command interpreting unit 13 detects variables (the variables are equivalent to the identifiers of the first data analysis command, for example) from the conditional expressions and searches the variable field of the variable-command table of FIG. 5(C), with the detected variables as the key. If the retrieval is unsuccessful, the command interpreting unit 13 returns an error to the user through the input-output device N. If the retrieval is successful, the command interpreting unit 13 transmits the command included in the retrieved entry to the data analyzing device designated based on the bit string in the forwarding destination information storage 14 through the communicating unit 12 and inspects whether the conditional expressions are satisfied, with the values indicating the result of the command execution returned from the data analyzing device as values of the variables of the conditional expressions. As for the data analyzing devices satisfying the conditional expressions, the bits of the forwarding destination information storage 14 are set to “1” (that is, “1” is maintained), and if not satisfied, the bits are set to “0” (changed from “1” to “0”).

For example, assuming that the user has inputted a command “connect(α>1.5)” to the input-output device N, the command “connect(α>1.5)” is transferred to the command interpreting unit 13 through the communicating unit 12. The command interpreting unit 13 searches the variable-command table of FIG. 5(C), with the variable “α” included in the conditional expression “α>1.5” as the key. The retrieval is successful, and a command “print α” corresponding to “α” is acquired. The command interpreting unit 13 then transmits the acquired command “print α” to the data analyzing devices having bits “1” in the forwarding destination information storage 14 through the communicating unit 12. Receiving the command “print α”, the data analyzing devices execute “print α” and return the execution results of the command (values of the variable “α”) to the connecting device 11. The command interpreting unit 13 receives the execution results of “print α” from the data analyzing devices through the communicating unit 12 and uses the received execution results as “α”. The command interpreting unit 13 inspects the data analyzing devices, which have returned the execution results, to find whether the conditional expression “α>1.5” is satisfied. The command interpreting unit 13 then maintains the bit “1” of the data analyzing devices satisfying the conditional expression in the forwarding destination information storage 14 and changes the bit to “0” if the conditional expression is not satisfied.

If the user has inputted a command “connect(β>1.5)” in the input-output device N, the result is as follows. The command interpreting unit 13 searches the variable-command table of FIG. 5(C), with the variable “β” included in a conditional expression “β>1.5” as the key, and then acquires commands

res<−lm(y˜x+z)
smry<−summary(res)
print(smry$sigma)
associated with “β” (identifier of the first data analysis command), as a result of the search. These commands are examples of orders written in the S language. The first line denotes a command for inputting results, such as a regression variable and a residual vector when a vector variable “y” is regressed by “x” and “z”, in the variable “res”. The second line is a command for calculating the standard deviation of the residual vector (hereinafter, simply referred to as “residual”) or the correlation coefficient from “res” and inputting the residual or the correlation coefficient in “smry”. The third line is a command for outputting the residual (variable “smry$sigma” in this example) from “smry”. The command interpreting unit 13 transmits the commands acquired by retrieving the variable-command table of FIG. 5(C) to the data analyzing devices having the bits “1” in the forwarding destination information storage 14. The residual data obtained by the data analyzing devices is returned to the connecting device 11, and the returned residual (=β) is compared to “1.5”. The bits of the data analyzing devices satisfying the conditional expression “β>1.5” are maintained “1” in the forwarding destination information storage 14, and the bits of the data analyzing devices not satisfying the conditional expression are changed to “0”.

An operation of the command interpreting unit 13 executing a “Register” command will now be described.

The “Register” command adopts group names as arguments. Receiving the “Register” command from the input-output device N through the communicating unit 12, the command interpreting unit 13 associates group names provided as arguments included in the “Register” command and a bit string currently stored in the forwarding destination information storage 14 and registers the association in the group-forwarding bit table of FIG. 5(B).

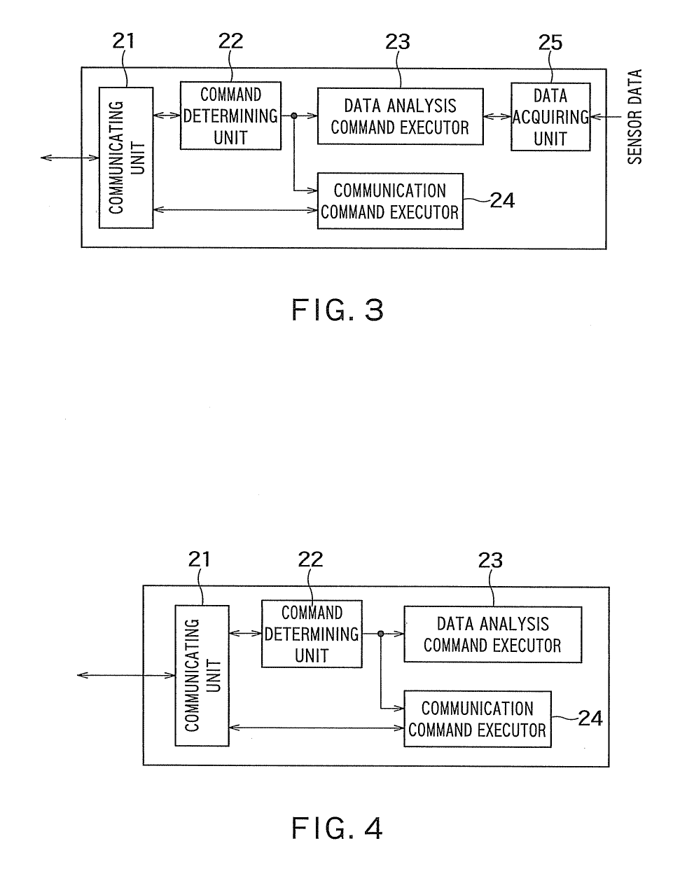

FIG. 3 illustrates a configuration of a local analyzing device. FIG. 4 illustrates a configuration of a center analyzing device.

The local analyzing device and the center analyzing device include communicating units 21, command determining units 22, data analysis command executors 23, and communication command executors 24. The local analyzing device further includes a data acquiring unit 25, which is a point different from the center analyzing device. Since the rest of the elements are identical, the elements are designated with the same reference numerals, and repeated description will be omitted.

The data acquiring unit 25 in the local analyzing device acquires observed values (observed data or sensor data) observed by a plurality of sensors that observe the local devices in time series. The data acquiring unit may include storage for storing the observed data acquired from the plurality of sensors. The acquired observed data is used for data analysis (for example, generation of predictive model, generation of monitoring logic, and evaluation of monitoring logic) executed by the data analysis command executor 23.

The command determining unit 22 receives various commands from the connecting device 11 through the communicating unit 21. Among the received-commands, the command determining unit 22 transfers communicating commands that are “put” orders (“put” commands) or “get” orders (“get” commands) to the communication command executor 24 and transfers the commands (data analysis commands such as “res<−lm(y˜x+z)”, “smry<−summary(res)”, and “print(smry$sigma)”) other than the communication commands to the data analysis command executor 23.

The communication command executor 24 in the local analyzing device is equivalent to, for example, a first communication command executor, and the data analysis command executor 23 in the local analyzing device is equivalent to, for example, a first analysis command executor. The “put” command executed in the communication command executor 24 of the local analyzing device is equivalent to, for example, a first communication command, and the “get” command executed in the communication command executor 24 of the local analyzing device is equivalent to, for example, a second communication command. The data analysis command executor 23 in the local analyzing device, for example, executes the first data analysis command based on the observed data acquired by the data acquiring unit 25 to execute the first data analysis and obtains the first analyzed data.

The communication command executor 24 in the center analyzing device is equivalent to, for example, a second communication command executor, and the data analysis command executor 23 in the center analyzing device is equivalent to, for example, a first analysis command executor. The “put” command executed in the communication command executor 24 of the center analyzing device is equivalent to, for example, a fourth communication command, and the “get” command executed in the communication command executor 24 of the center analyzing device is equivalent to, for example, a third communication command. The data analysis command executor 23 in the center analyzing device, for example, executes the second data analysis command based on the first analyzed data obtained in the local analyzing device to execute the second data analysis and obtains the second analyzed data.

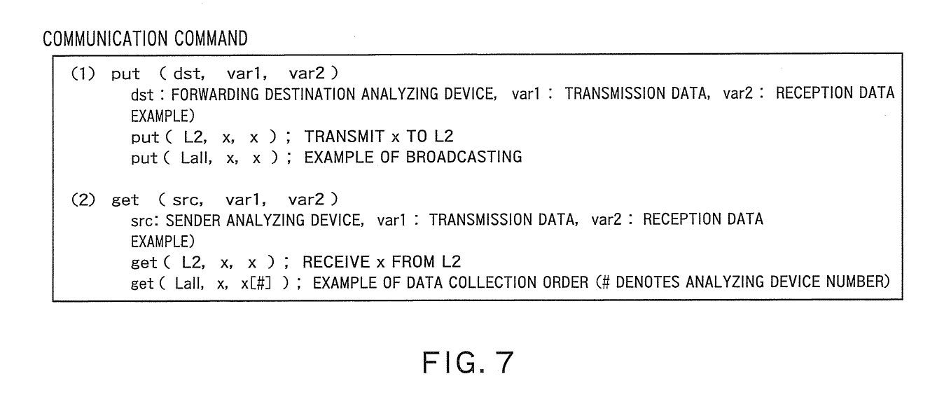

FIG. 7 is a view for describing the “put” order and the “get” order in detail.

The “put” order adopts three arguments: “dst”, “var1”, and “var2”. The argument “dst” denotes the data analyzing device of the transmission destination. The argument “var1” denotes a variable (transmission data) to be transmitted to the transmission destination. The argument “var2” denotes a variable (reception data) to be written in the transmission destination. For example, “put(L2, x, x)” instructs to write the variable “x” (“x” on the left side in the “put” command) of the data analyzing device executing the “put” command into “x” (“x” on the right side of the “put” command) of the data analyzing device L2. The “put(Lall, x, x)” instructs to broadcast the variable “x” of the data analyzing device executing the “put” command to all local analyzing devices (Lall) and to write it into each variable “x” (see FIG. 5(B)).

The “get” order adopts three arguments: “src”, “var1”, and “var2”. The argument “src” denotes the data analyzing device of the sender. The argument “var1” denotes a variable (transmission data) transmitted from the sender. The argument “var2” denotes a variable (reception data) written from the sender. For example, “get(L2, x, x)” instructs to write the variable “x” (“x” on the left side of the “get” command) of the data analyzing device L2 into the variable “x” (“x” on the right side of the “get” command) of the data analyzing device executing the “get” command. The “get(Lall, x, x[#])” instructs to write the variables “x” of all local analyzing devices (Lall) into the variables “x[#]” of the data analyzing devices executing the “get” command. Reference character herein “#” denotes a data analyzing device number. Therefore, “x” of the data analyzing device L1 is written into “x[L1]”, while “x” of the data analyzing device L2 is written into “x[L2]”.

As described, the “put” command and the “get” command are interpreted and executed by the communication command executors 24 in the data analyzing devices and are realized as follows. The communication command executor 24 of the data analyzing device that receives and executes the “put” command transfers a data writing command for instructing to write data in the data analyzing device of the transmission destination indicated by the argument “dst” of the “put” command and then transmits the data to be written into the data analyzing device. The communication command executor 24 in the data analyzing device of the transmission destination interprets the data writing command and writes the data transmitted from the data analyzing device that has executed the “put” command into the variable indicated by the data writing command. The “get” command is realized in the same way. The communication command executor 24 of the data analyzing device that receives and executes the “get” command transmits a data transmission command to the data analyzing device of the sender indicated by the argument “src” of the “get” command. The data analyzing device of the sender interprets and executes the data transmission command and transmits the variable (data) indicated by the data transmission command to the data analyzing device that has executed the “get” command. The communication command executor 24 in the data analyzing device that executes the “get” command stores the data received from the data analyzing device of the sender in the variable indicated by the argument of the “get” command. As described above, the “put” command and the “get” command are transmitted to the destination device in a direct message scheme.

Although the realization of the “put” command and the “get” command has been described on the basis of commands, the realization by asynchronous communication is also possible. Thus, the present invention can be implemented on the basis of commands and in asynchronous communication. Taking the “get” command as an example, in a command-based case, the transmission of data to the data analyzing device of the sender indicated by the argument “src” is requested by a command (request command). In asynchronous communication, request data may request the transmission of data. Receiving the request command or the request data, the data analyzing device can return data requested by the request command or the request data. The data analyzing device includes a sending unit that sends the data requested by the request command or the request data. The communication command executor 24 may execute the request command to return the data requested by the request command.

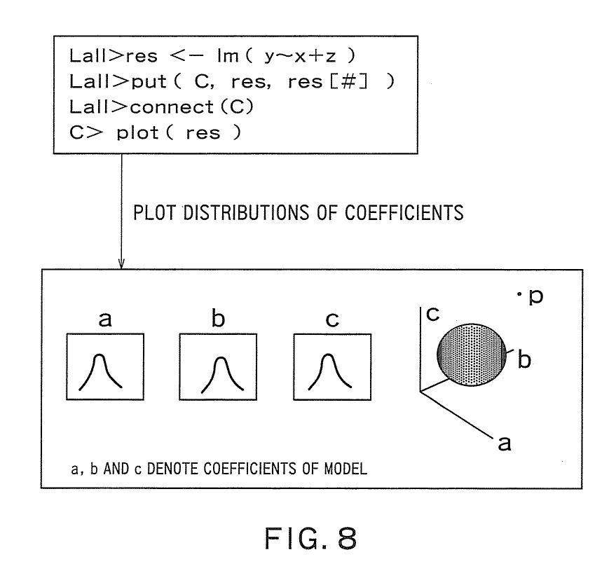

FIG. 8 illustrates an example (analysis example 1) in which the local analyzing devices L1 to Ln connected with the local devices analyze sensor data (observed data) detected by the sensors of all local devices #1 to #n to generate monitoring logics, and the parameters of the generated monitoring logics are transmitted to the center analyzing device C and evaluated by the center analyzing device C. Reference characters “x”, “y”, and “z” denote time series data of the sensors X, Y, and Z in the local devices, with Y being the monitored sensor.

The user uses the input-output device N to transmit the command “connect(Lall)” to the connecting device 11 in advance. The command interpreting unit 13 in the connecting device 11 then interprets and executes the command. As a result of the execution, the forwarding destinations of the connecting device 11 are set to all local devices #1 to #n (“0111111111” is stored in the forwarding destination information storage 33 when n=9), and “Lall>” is displayed on the command prompt screen of the input-output device N.

The user then inputs the command “res<−lm(y˜x+z)” of the first line on the right side of “Lall>” and transmits the command to the connecting device 11. Receiving the command, the command interpreting unit 13 in the connecting device 11 determines that the command interpreting unit 13 is not to execute the command because the command is not the “connect” command or the “register” command. The command interpreting unit 13 forwards the command to all local analyzing devices through the communicating unit 12. The command determining unit 22 in each local analyzing device determines that the command forwarded from the connecting device 11 is a data analysis command and transfers the command to the data analysis command executor 23. The data analysis command executor 23 interprets and executes the command transferred from the command determining unit 22. As a result of the execution of the command “res<−lm(y˜x+z)”, a vector variable “y” is regressed by “x” and “z”, a predictive model of “Y” including a regression variable obtained by regression, a residual vector, and the like is generated, and a monitoring logic of the sensor “Y” including the predictive model is inputted to the variable “res”. In other words, the analyzer connects to all analyzing devices (set as forwarding destinations) in the first line, generates a model in which “Y” is regressed by “X” and “Z”, and creates monitoring logics “y˜N(a+bx+cz, σ)” for respective analyzing devices by using the model. Thus, when certain observed values “x”, “y”, and “z” are provided, “y” is predicted from “x” and “z” based on the regression model. If “y” is in the range of ±nσ from the predicted value (i.e., a+bx+cz), the value of “y” can be determined to be normal, and if not, the value of “y” can be determined to be abnormal. The parameter “n” is determined by the user.

The user then inputs a command “put(C, res, res[#])” on the right side of “Lall>” in the second line of the command prompt screen and transmits the command to the connecting device 11. After receiving the command, the command interpreting unit 13 in the connecting device 11 forwards the command to all local analyzing devices through the communicating unit 12. The command determining unit 22 of each local analyzing device determines that the command forwarded from the connecting device 11 is a communication command and transfers the command to the communication command executor 24. The communication command executor 24 interprets and executes the command transferred from the command determining unit 22. As a result of the execution of the command “put(C, res, res[#])”, the variable “res” obtained by the data analysis command executor 23 of each local analyzing device is transmitted to the center device C and stored in the variable “res[#]” corresponding to each local analyzing device in the center device C. In other words, the parameters of the individual monitoring logics created by the command of the first line are transmitted to the center analyzing device as a result of the execution of the command of the second line.

The user then inputs a command “connect(C)” on the right side of “Lall>” in the third line of the command prompt screen and transmits the command to the connecting device 11. Receiving the command, the command interpreting unit 13 in the connecting device 11 interprets and executes the command. As a result of the execution, the forwarding destination of the connecting device 11 is changed from all local devices #1 to #n to only the center device C (“1000000000” is stored in the forwarding destination information storage 33 when n=9), and “C>” is displayed on the command prompt screen of the input-output device N. In other words, the forwarding destination of the input-output device N is changed from all local analyzing devices to the center analyzing device C.

The user then inputs a command “plot(res)” on the right side of “C>” in the fourth line of the command prompt screen and transmits the command to the connecting device 11. The command interpreting unit 13 in the connecting device 11 receives the command and transmits the command to the center device C. The command determining unit 22 in the center device C transfers this command to the data analysis command executor 23. The data analysis command executor 23 interprets and executes the command transferred from the command determining unit 22. As a result of the execution of the command “plot(res)”, the distribution of various parameters (parameters of the predictive model) included in the argument “res” is plotted, and the plotted graph data is transmitted to the input-output device N through the connecting device 11 and displayed. Thus, the parameters of the monitoring logics obtained in the local analyzing devices are visualized.

The graph at the lower part of FIG. 8 illustrates distributions of coefficients “a”, “b”, and “c” of the predictive models generated in all local analyzing devices and a distribution of “a”, “b”, and “c” on a three-dimensional space. Viewing the distributions enables to determine the deviation of the monitoring logics (predictive models included in the monitoring logics) generated in the local analyzing devices. For example, in the distributions of the coefficients “a”, “b”, and “c”, a local device having coefficients “a”, “b”, and “c” that are significantly out of the distributions (for example, a local device of a local analyzing device that has outputted a point “p”) can be determined as having some kind of uniqueness or abnormality. The analyzer then connects to the local analyzing device that has outputted the point p and determines, while looking at the detailed data, whether to employ the coefficients “a”, “b”, and “c” as it is or to create new monitoring logics. In this way, the monitoring logics reflecting the individual differences of the individual monitored devices can be generated. The sensor data of the local devices does not have to be collected in the center analyzing device as in the prior art, and as in the above example, only the parameters of the monitoring logics or the predictive models with less data need to be acquired. Therefore, the monitoring logics reflecting the individual differences of the individual monitored devices can be easily and quickly created, reducing the loads of the center analyzing device and the communication. JP-A 2001-167098 (Kokai) described in the section of BACKGROUND OF THE INVENTION is designed to apply a preset, identical process to identical data. Therefore, it is difficult to create the monitoring logics taking into account the individual differences while the analyzer interactively implementing the analytical work to the data of different monitored devices.

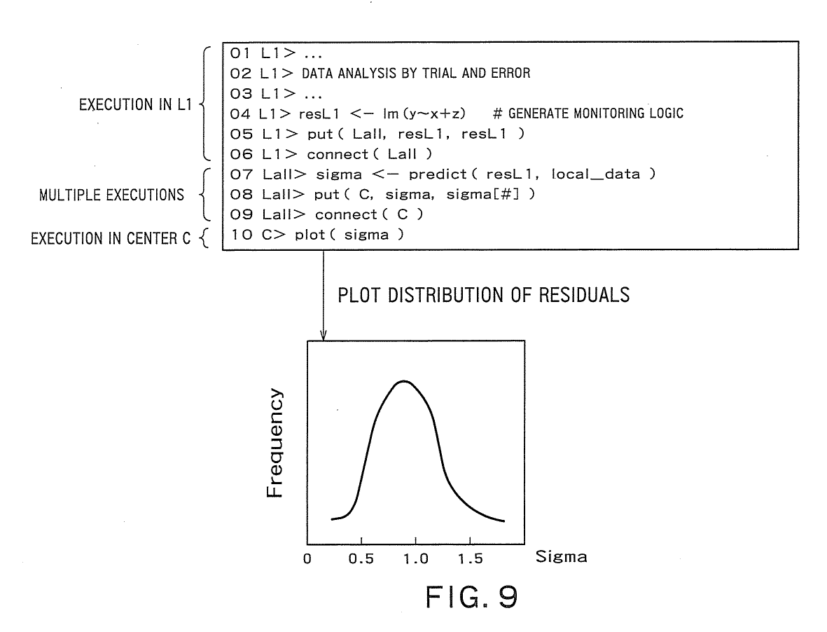

FIG. 9 illustrates an example (analysis example 2) in which the monitoring logics are generated in one local analyzing device and the fitness of the monitoring logics are verified in the rest of the local analyzing devices.

The user connects to the local analyzing device L1 and uses various data analysis commands to analyze the sensor data detected by the local device #1 connected to the local analyzing device L1 through trial and error (process of the trial and error is abbreviated in the first three lines in FIG. 9).

It is assumed that the fact is found out that the predictive model of “Y” generated from the sensors “X” and “Z” is preferably used for the monitoring logic of the sensor “Y”, and the monitoring logic using the predictive model is generated for the sensor “Y”. Specifically, the user inputs a command “resL1<−lm(y˜x+z)” of the fourth line from the input-output device N to cause the local analyzing device L1 to execute the command, thereby generating the monitoring logic including the predictive model of the local analyzing device L1 and assigning the monitoring logic to “resL1”. Reference characters “x”, “y”, and “z” denote time series data of the sensors “X”, “Y”, and “Z” respectively.

To examine the distribution of the residual a when applying the predictive model to the sensor data of other local devices, the user inputs a command “put(Lall, resL1, resL1)” of the fifth line from the input-output device N to cause the local analyzing device L1 to execute the command, thereby transmitting “resL1” including the parameters of the monitoring logic from the local analyzing device L1 to all other local analyzing devices (the “resL1” is also returned to the local analyzing device L1 so that the “resL1” held by the local analyzing device L1 is overwritten by the same returned data. Alternatively, the data transmission to the local analyzing device L1 may also be omitted).

The user then inputs a command “connect(Lall)” of the sixth line from the input-output device N to cause the connecting device 11 to execute the command, thereby connecting the input-output device N of the user to all local analyzing devices. The user inputs a command “sigma<−predict(resL1, local_data)” of the seventh line from the input-output device N to cause all local analyzing devices to execute the command, thereby using the sensor data (local_data) acquired by the data acquiring units 25 of the individual local analyzing devices and the predictive model included in the monitoring logic “resL1” to find the residual σ and assign the residual σ to “sigma”.

The user then inputs a command “put(C, sigma, sigma[#]) of the eighth line from the input-output device N to cause all local analyzing devices to execute the command, thereby transmitting the residuals obtained in the local analyzing devices to the center analyzing device from the local analyzing devices. The user then inputs a command “connect(C)” of the ninth line from the input-output device N to cause the connecting device 11 to execute the command, thereby connecting the input-output device N to the center analyzing device C. The user inputs a command “plot(sigma)” of the tenth line from the input-output device N to cause the center analyzing device C to execute the command, thereby plotting the distribution of the residuals obtained by the local analyzing devices. The plotted graph of the distribution of the residuals is transmitted from the local analyzing devices to the input-output device N through the connecting device 11. The input-output device N displays the graph of the distribution of the residuals received from the center analyzing device through the connecting device 11 (see lower part of FIG. 9).

Viewing the graph enables to visually figure out the fitness of the monitoring logic generated by the local analyzing device L1 in other local analyzing devices. For example, if a residual in the local analyzing device L1 that has generated the monitoring logic approximately matches the peak of the graph (frequency distribution), there is no problem in applying the monitoring logic generated in the local analyzing device L1 to other local devices. If the residual is significantly out of the peak of the graph, the monitoring logic cannot be applied as it is. For example, it can be determined that the predictive model used for the monitoring logic should be changed (although “y” has been regressed by “x” and “z”, the predictive model will be generated by another method).

After the execution of the command “plot(sigma)” of the tenth line of FIG. 9, it is assumed that the user has inputted commands “connect(Lall)” and “connect(sigma>1.5)” from the input-output device N to cause the connecting device 11 to sequentially execute the commands. It is assumed that “print(sigma)” is stored in the variable-command table of FIG. 5(C) (not shown) as a command corresponding to the variable “sigma”. The execution of “connect(sigma>1.5)” changes the forwarding destinations of the input-output device N from all local analyzing devices to local analyzing devices having residual “sigma” greater than “1.5”. The local analyzing devices that are forwarding destinations after the change have greater residuals compared to other local analyzing devices. An example of the local analyzing devices that are forwarding destinations after the change includes analyzing devices in which whether the monitoring logic obtained in the local analyzing device L1 can be applied as it is needs to be verified. Although the user will continue further detailed analytical work, the user can designate the forwarding destinations by the conditions, not explicitly by the analyzing device names, so that the load of the analytical work by the user can be reduced.

### Second Embodiment

In the first embodiment, the data analyzing device (local analyzing device, center analyzing device) includes a communication command executor, and the communication command executor executes the “put” command or the “get” command to realize a function for writing the values of the variables of the data analyzing device into the variables of other data analyzing devices or a function for writing the values of the variables of other data analyzing devices into the variables of the data analyzing device. On the other hand, the second embodiment is characterized in that the functions are provided in the connecting device, not in the data analyzing device.

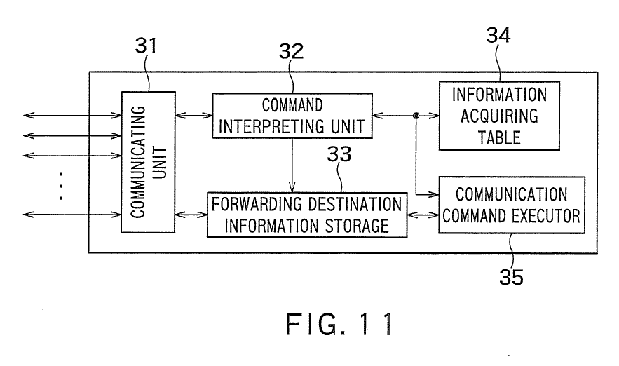

FIG. 11 illustrates a configuration of the connecting device according to the present embodiment.

The connecting device of FIG. 11 includes a communicating unit 31, a command interpreting unit 32, the forwarding destination information storage 33, and an information acquiring table 34, and a communication command executor 35. The communicating unit 31, the forwarding destination information storage 33, and the information acquiring table 34 have similar functions as the connecting device shown in the first embodiment. However, after receiving a communication command, the command interpreting unit 32 forwards the communication command to the communication command executor 35. The communication command executor 35 is equivalent to, for example, a third communication command executor. A “put” command executed in the communication command executor 35 is equivalent to a fifth communication command. A “get” command executed in the communication command executor 35 is equivalent to, for example, a sixth communication command.

It is assumed that the communication command executor 35 receives “put(dst, var1, var2)” as a communication command and executes the command. With the execution of the command, the communication command executor 35 searches the forwarding destination information storage 33 and transmits a command (order) that outputs the variable “var1” to the data analyzing devices in which “1” is set. The communication command executor 35 receives “var1” from the data analyzing devices in which “1” is set and issues and transmits a variable assigning command for assigning the received “var1” to “var2” of the data analyzing device of “dst” to the data analyzing device indicated by “dst”.

For example, assuming that “put(L2, x, x)” is executed in the communication command executor 35 and “1” is only set in “L3” in the forwarding destination information storage 33, the communication command executor 35 transmits a command “print x” to the data analyzing device L3 and acquires a variable “x” from the data analyzing device L3 (it is assumed herein that “x” is 1.28). The communication command executor 35 issues a command “x<−1.28” to the data analyzing device L2 based on the acquired variable “x”. The command “x<−1.28” is executed in the data analyzing device L2, and a value “1.28” is written into the variable “x” in the data analyzing device L2. If “put(L2, x, x[#])” is executed and the bit “1” is set to a plurality of data analyzing devices in the forwarding destination information storage 33, the communication command executor 35 transmits the command “print x” to the data analyzing devices to acquire variables “x” and writes the variables “x” acquired from the data analyzing devices into “x[#]” (array variable) in the data analyzing device L2. Reference character “#” denotes names of data analyzing devices.

Meanwhile, it is assumed that the communication command executor 35 has received “get(src, var1, var2)” as a communication command and executed the command. With the execution of the command, the communication command executor 35 transmits a command for transmitting the variable “var1” to the data analyzing device indicated by “src”. The communication command executor 35 receives the variable “var1” from the data analyzing device and issues variable assigning commands for substituting the received variable “var1” for “var2” in the data analyzing devices in which the bit “1” is set in the forwarding destination information storage 33.

For example, assuming that “get(L2, x, x)” is executed in the communication command executor 35 and “1” is only set in “L3” in the forwarding destination information storage 33, the communication command executor 35 transmits “print x” to the data analyzing device L2 and acquires a variable “x” from the data analyzing device L2 (it is assumed herein that “x” is 2.46). The communication command executor 35 issues a command “x<−2.46” to the data analyzing device L3 based on the acquired variable “x”. The command “x<−2.46” is executed in the data analyzing device L3, and a value “2.46” is written into the variable “x” in the data analyzing device L3. If “get(L3, x[#], x)” is executed and the bit “1” is set to a plurality of data analyzing devices in the forwarding destination information storage 33, the communication command executor 35 acquires the values “x[#]” of the array variable from the data analyzing device L3 and writes the values “x[#]” acquired from the data analyzing device L3 into the variables “x” of the data analyzing devices “#”. Reference character “#” denotes names of the data analyzing devices in which bit “1” is set in the forwarding destination information storage 33.

The analysis examples 1 and 2 shown in the first embodiment can also be implemented in the second embodiment in a similar manner. In that case, unlike the data analyzing devices of the first embodiment, the data analyzing devices in the second embodiment are advantageous in that there is no need to include functions for executing special communication commands.

### Third Embodiment

Although the local analyzing devices in the first and second embodiments are assumed to be the same type of devices, the data analysis commands executable in the devices may be different if the local analyzing devices are different types of devices. The third embodiment is characterized in that the information acquiring table in the connecting device is expanded to absorb the difference between the data analysis commands executable in the local analyzing devices.

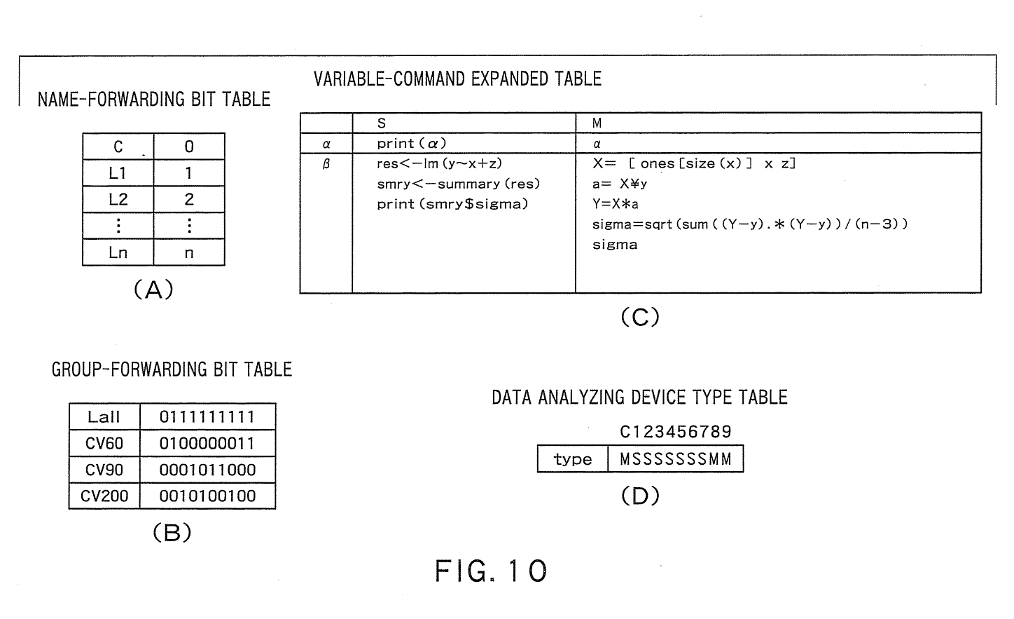

FIG. 10 illustrates an information acquiring table according to the present embodiment.

The information acquiring table includes a name-forwarding bit table shown in FIG. 10(A), a group-forwarding bit table shown in FIG. 10(B), a variable-command expanded table shown in FIG. 10(C), and a data analyzing device type table shown in FIG. 10(D). The tables in FIGS. 10(A) and 10(B) are the same as the tables in FIGS. 5(A) and 5(B) described in the first embodiment. Therefore, the description will be omitted.

The data analyzing device type table of FIG. 10(D) manages the types of the individual data analyzing devices. In the present embodiment, the data analyzing device (center analyzing device) C and the data analyzing devices (local analyzing devices) 8 and 9 are type “M” analyzing devices, while the data analyzing devices (local analyzing devices) 1 to 7 are type “S” analyzing devices.

The variable-command expanded table of FIG. 10(C) is a table in which the variable-command table of FIG. 5(C) shown in the first embodiment is expanded. Although a specific command is associated to each variable in the table of FIG. 5(C), the commands to be associated with the variables are differed depending on the type in the table of FIG. 10(C).

An example of executing a command using the tables of FIGS. 10(C) and 10(D) is as follows.

It is assumed that “connect(α>1.5)” is inputted from the input device N and executed in the connecting device 11, with the input-output device N being connected to all data analyzing devices. In this case, a command “print(a)” is transmitted to the type “S” data analyzing devices 1 to 7 as shown in FIG. 10, and a command “α” is transmitted to the data analyzing devices C, 8, and 9. The command “α” herein denotes a command for instructing an output (transmission) of the value of “α”.

If “connect(β>1.5)” is executed, different command groups written in the variable-command expanded table as shown in FIG. 10 are transmitted to the type “S” and type “M” data analyzing devices.

In this way, the expansion of the information acquiring expanded table in the present embodiment enables to select forwarding destinations and analyze data, where the differences between the data analyzing devices are absorbed.

What is claimed is:

1. A data analyzing system comprising:
an input-output device operated by a user;
a plurality of local analyzing devices each of which performs a first data analysis of analyzing observed values obtained from each of local devices corresponding each of the local analyzing devices to obtain first analyzed data, respectively;
a center analyzing device which performs a second data analysis of analyzing the first analyzed data to obtain second analyzed data; and
a connecting device which connects between the input-output device, the local analyzing devices, and the center analyzing device,
(A) the input-output device comprising:
an inputting unit configured to input a command by the user;
a first communicating unit configured to transmit an inputted command to the connecting device and to receive data from the center analysis device and the local analysis devices via the connecting device; and
a data outputting unit configured to output received data,
(B) each of the local analyzing devices comprising:
a second communicating unit configured to transmit and receive a command or data to and from the input-output device, the center analysis device and other local analyzing devices via the connecting device;
a data acquiring unit configured to acquire observed values from the local devices corresponding to the local analyzing devices;
a first analysis command executor configured to receive and execute a first data analysis command from the input-output device through the second communicating unit to perform the first data analysis using the observed values and configured to transmit the first analyzed data to the input-output device through the second communicating unit; and
a first communication command executor configured to receive and execute a first communication command through the second communicating unit from the input-output device to provide the first analyzed data to at least one of the center analyzing device and other local analyzing devices and configured to receive and execute a second communication command through the second communicating unit from the input-output device to acquire the first or second analyzed data from at least one of the center analyzing device and the other local analyzing devices,
(C) the center analyzing device comprising
a third communicating unit configured to transmit and receive a command or data to and from the input-output device and the local analysis devices via the connecting device; and
a second analysis command executor configured to receive and execute a second data analysis command through the third communicating unit from the input-output device to perform the second data analysis using the first analyzed data acquired in advance and configured to transmit the second analyzed data to the input-output device through the third communicating unit, and
(D) the connecting device comprising:
a command executing unit configured to receive and execute a forwarding setting command from the input-output device to select and set one or more devices, to which the command from the input-output device should be forwarded, from the local analyzing devices and the center analyzing device;
a first forwarding unit configured to forward a command different from the forwarding setting command transmitted from the input-output device to the devices, in which forwarding is set; and
a second forwarding unit configured to forward data or command transmitted from the local analyzing devices and the center analyzing device, in accordance with destinations described in the data or the command.

2. The system according to claim 1, wherein
the local analyzing device further comprises a sending unit configured to send data requested from the other local analyzing devices or the center analyzing device,
the first communication command executor in the local analyzing device
executes the first communication command so as to transmit the first analyzed data to at least one of the center analyzing device and the other local analyzing devices; and
executes the second communication command to transmit a request command or request data for requesting transmission of the first or second analyzed data to at least one of the other local analyzing devices and the center analyzing device and thereby receive the first or the second analyzed data from at least one of the other local analyzing devices and the center analyzing device through the second communicating unit, and
when receiving the request command or the request data from the other local analyzing devices or the center analyzing device, the sending unit in the local analyzing device transmits the first or the second analyzed data requested by the request command or the request data to the other local analyzing devices or the center analyzing device.

3. The system according to claim 1, wherein
the center analyzing device further comprises a second communicating command executor configured to receive and execute a third communication command from the input-output device through the third communicating unit to acquire the first analyzed data from at least one of the local analyzing devices or a fourth communication command from the input-output device through the third communicating unit to provide the second analyzed data to at least one of the local analyzing devices.

4. The system according to claim 1, wherein
the command executing unit in the connecting device executes the forwarding setting command which includes a variable specifying the first analyzed data and a conditional expression to
transmit a command for instructing transmission of the first analyzed data specified by the variable to local analyzing devices in which the forwarding is set;
acquire the first analyzed data specified by the variable from the local analyzing devices to which the command has been forwarded; and
maintain the forwarding setting only for the local analyzing devices in which acquired first analyzed data satisfies the conditional expression, and
the first analysis command executor in the local analyzing device executes the command forwarded by the connecting device to transmit the first analyzed data specified by the variable to the connecting device.

5. The system according to claim 4, wherein the connecting device includes
a device type table configured to describe device types of the local analyzing devices and
a command table configured to hold commands having different descriptions depending on the device types as the command for instructing transmission of the first analyzed data,
the command executing unit in the connecting device specifies a device type of the local analyzing devices, in which the forwarding is set, according to the device type table respectively, specifies a command corresponding to a specified device type according to the command table respectively, and transmits a specified command corresponding to the device type to the local analyzing devices of the device type in which the forwarding is set, respectively.

6. The system according to claim 1, wherein the connecting device includes
a second command table configured to associate the first data analysis command with an identifier, and
the command executing unit in the connecting device executes the forwarding setting command which includes the identifier and the conditional expression to
specify the first data analysis command corresponding to the identifier included in the forwarding setting command according to the second command table;
transmit a specified first data analysis command to local analyzing devices in which the forwarding is set;
acquire the first analyzed data from the local analyzing devices to which the first data analysis command has been forwarded and
maintain the forwarding setting only for the local analyzing devices in which acquired first analyzed data satisfies the conditional expression.

7. The system according to claim 6, wherein the connecting device includes a device type table describing the device types of the local analyzing devices, and
the second command table holds first data analysis commands having different descriptions corresponding to the device types, correspondingly to the identifier of the first data analysis command, and
the command executing unit in the connecting device specifies a device type of the local analyzing devices, in which the forwarding is set, in the device type table respectively, specifies the first data analysis command corresponding to a set of a specified device type and the identifier included in the forwarding setting command according to the second command table respectively, and transmits a specified first data analysis command corresponding to the set to the local analyzing devices of the device type in which the forwarding is set, respectively.

8. The system according to claim 1, wherein
the first analysis command executor in the local analyzing devices executes the first data analysis command to generate a predictive model for predicting one observed value of the observed values from other observed values of the observed values.

9. The system according to claim 1, wherein
the first analysis command executor in the local analyzing devices executes the first data analysis command to generate a predictive model for predicting one of the observed values from others of the observed values and further generate a monitoring logic for monitoring whether or not a state of the local device is abnormal based on the predictive model and the observed values.

10. The system according to claim 8, wherein
the first communication command executor in the local analyzing device executes the first communication command to provide the predictive model to other local analyzing devices designated by the first communication command,
the first analysis command executor of the other local analyzing devices executes the first data analysis command to calculate a fitness value for the predictive model provided from the local analyzing device based on the observed values acquired by the data acquiring unit, and
the second analysis command executor in the center analyzing device executes the second data analysis command to calculate a distribution of fitness values acquired in advance from the other local analyzing devices.

11. The system according to claim 8, wherein
the second analysis command executor in the center analyzing device executes the second data analysis command to calculate a distribution of parameters of the predictive model acquired in advance from the local analyzing devices.

12. The system according to claim 10, wherein
the second analysis command executor in the center analyzing device further transmits graph data of the calculated distribution to the input-output device through the third communicating unit, and
the data outputting unit in the input-output device receives the graph data transmitted through the first communicating unit from the center analyzing device and outputs the graph data.

13. A data analyzing system comprising:
an input-output device operated by a user;
a plurality of local analyzing devices each of which performs a first data analysis by using observed values obtained by observing local devices corresponding the local analyzing devices to obtain first analyzed data, respectively;
a center analyzing device configured to perform a second data analysis using the first analyzed data to obtain second analyzed data; and
a connecting device configured to connect between the input-output device, the local analyzing devices, and the center analyzing device,
(A) the input-output device comprising:
an inputting unit configured to input a command by the user;
a first communicating unit configured to transmit an inputted command to the connecting device and to receive data from the center analysis device and the local analysis devices via the connecting device; and
a data outputting unit configured to output received data,
(B) each of the local analyzing devices comprising:
a second communicating unit configured to transmit and receive a command or data to and from the input-output device, the center analysis device and other local analyzing devices via the connecting device;
a data acquiring unit configured to acquire observed values by observing the local devices corresponding to the local analyzing devices; and
a first analysis command executor configured to receive and execute a first data analysis command through the second communicating unit from the input-output device to perform the first data analysis using the observed values and configured to transmit the first analyzed data to the input-output device through the second communicating unit;
(C) the center analyzing device comprising
a third communicating unit configured to transmit and receive a command or data to and from the input-output device and the local analysis devices via the connecting device; and
a second analysis command executor configured to receive and execute a second data analysis command through the third communicating unit from the input-output device to perform the second data analysis using the first analyzed data acquired in advance and configured to transmit the second analyzed data to the input-output device through the third communicating unit, and
(D) the connecting device comprising:
a command executing unit configured to receive and execute a forwarding setting command from the input-output device to select and set one or more devices, to which the command from the input-output device should be forwarded, from the local analyzing devices and the center analyzing device;
a first forwarding unit configured to forward a command different from the forwarding setting command transmitted from the input-output device to devices, in which forwarding is set;
a second forwarding unit configured to forward data or a command transmitted from the local analyzing devices and the center analyzing device, in accordance with destinations of the data or the command; and
a third communication command executor
configured to receive and execute a fifth communication command from the input-output device to acquire the first or second analyzed data from the local analyzing devices or the center analyzing device in which the forwarding is set and provide acquired data to at least one of the center analyzing device and the local analyzing devices and
configured to receive and execute a sixth communication command from the input-output device to acquire the first or second analyzed data from at least one of the center analyzing device and the local analyzing devices and provide acquired data to the center analyzing device and the local analyzing devices in which the forwarding is set.

14. A method of performing data analysis by using an input-output device operated by a user; a plurality of local analyzing devices each of which performs a first data analysis to obtain first analyzed data; a center analyzing device which performs a second data analysis of analyzing the first analyzed data to obtain second analyzed data; and a connecting device which connects between the input-output device, the local analyzing devices, and the center analyzing device, comprising:
acquiring observed values from each of local devices corresponding to each of the local analyzing devices;
selecting one or more local analyzing devices to which the command from the input-output device should be forwarded and setting selected local analyzing devices to the connecting device;
transmitting a first data analysis command for performing the first data analysis of analyzing the observed values from the input-output device to the connecting device and forwarding by the connecting device the first data analysis command to said set local analyzing devices to make said set local analyzing devices to execute the first data analysis;
transmitting the first analyzed data obtained by the first data analysis from said set local analyzing devices to the input-output device via the connecting device;
transmitting the first analyzed data obtained by said set local analyzing devices to the center analyzing device via the connecting device;
setting the center analysis device to the connecting device as a device to which the command from the input-output device should be forwarded;
transmitting a second data analysis command for performing the second data analysis of analyzing the first analyzed data from the input-output device to the connecting device and forwarding by the connecting device the second data analysis command to said set center analysis device to make said set center analysis device to execute the second data analysis command; and
transmitting the second analyzed data obtained by the second data analysis from the center analysis device to the input-output device via the connecting device.
